(19) United States
(12) Patent Application Publication
(10) Pub. No.: US 2006/0165287 A1
(43) Pub. Date: Jul. 27, 2006

(54) Photo and text discriminating method

(75) Inventor: Chun-Chia Huang, Taipei (TW)

Correspondence Address: HDSL, 4331 STEVENS BATTLE LANE, FAIRFAX, VA, 22033, US

(73) Assignee: Destiny Technology Corporation

(21) Appl. No.: 11/043,105

(22) Filed: Jan. 27, 2005

(51) Int. Cl. G06K 9/34

(52) U.S. Cl. 382/176

(57) ABSTRACT

A photo and text discriminating method is provided. The gray scale image of an input image is obtained, and a plurality of text blocks and a plurality of photo blocks of the gray scale image are distinguished. Whether the text blocks are amplitude-modulation or frequency-modulation halftone photo blocks are determined, and the text blocks are processed by a method different than that used for processing the photo blocks.

### BACKGROUND OF THE INVENTION

1. Field of the Invention

The invention relates to a photo and text discriminating method, and more particularly to a photo and text discriminating method applied to a multi-function peripheral (MFP) that improves the separation of photos and texts, such that the quality of an output image is enhanced.

2. Description of Related Art

A multi-function peripheral is an image processing apparatus that has at least two of the functions of scanning, copying, printing or faxing.

For the copying function of a multi-function peripheral, if the input image includes both a text region and a photo region, a photo and text discriminating function is required to distinguish the photos from the texts, such that the photo and text can be processed according to their specific characteristics for obtaining a high-quality image. For example, the photo-coupling device has a problem correcting RGB colors. As the photo-coupling device is insensitive to the edge of black text, an edge enhancement filter is required for certain texts. Typically, a de-screening filter is required for processing the photos. By the above processes, the output image is not distorted.

Discriminating the photos and texts first also has the following advantages. The black texts can be printed with black ink or toner instead of the mixture of color ink or toner. Thereby, the output time can be shortened, and the amount of ink and toner can be reduced. The image distortion of a copy machine is basically determined by the photo and text discriminating process. For example, if the photo content of an image is processed as the text content, the de-screening process will be replaced by an edge enhancement process, resulting in a rough or unnatural image.

In other words, the fidelity of an output image can only be obtained by proper photo and text discriminating processes.

Currently, the halftone screening technique used for printing photos and texts normally includes amplitude modulation (AM) screening or frequency modulation (FM) screening. When the photo regions printed by the above technique are comprised of black spots, the “level crossing density” technique or the “peak density” technique is frequently used for discriminating photos and texts. Thereby, the spot layout of the black spots is easily misjudged, resulting in the photo being processed as text. Thus the correct image cannot be obtained.

According to the above, to provide an improved and correct image output for a copier, a scanner or a multi-function peripheral, a more effective method for discriminating photo and text of an input image is required.

### BRIEF SUMMARY OF THE INVENTION

It is an object to provide a method of discriminating photos and texts to apply to a copier, a scanner or a multi-function peripheral to prevent misjudging the photos and texts of an input image. Thereby, the fidelity of the output image can be improved.

It is a another object to provide a method of discriminating photos and texts to apply to a copier, a scanner and a multi-function printer to effectively distinguish the photo and text of an input image, or effectively distinguish the photo or text formed by amplitude or frequency modulation techniques.

Accordingly, the photo and text discriminating method of the invention includes: obtaining a gray scale image, dividing the gray scale image into a plurality of text blocks and a plurality of photo blocks, and determining whether each of the text blocks comprises a photo block formed of amplitude- or frequency-modulation screening techniques.

The above-mentioned step of determining whether each text block includes the amplitude- or frequency-modulation photo block includes: obtaining a brightness distribution for the text block; equidistantly and horizontally dividing the text block into the block lines; obtaining numbers of peak-to-crest and crest-to-peak for each block line according to brightness distribution thereof; obtaining a difference of the sums between adjacent block lines, comparing the difference to a first threshold, adding one to an amplitude-modulation counter when the difference is smaller than the first threshold, comparing a value of amplitude-modulation counter to a second threshold, determining the text block as a real text block when the value is smaller than the second threshold, and determining the text block is a amplitude-modulation photo block when the value is greater than the second threshold.

Alternatively, the above-mentioned step of determining whether each text block includes the amplitude- or frequency-modulation photo block includes: obtaining a brightness distribution for each block line; equidistantly and horizontally dividing the text block into the block lines; obtaining numbers of peak-to-crest and crest-to-peak for each block line according to brightness distribution thereof, obtaining a ratio between the numbers of peak-to-crest and crest-to-peak for each block line, obtaining a difference of the ratios the adjacent block lines, comparing the difference to a first threshold, adding one to a value of frequency-modulation counter when the difference is smaller than the first threshold, determining the text block as a real text block when the value is smaller than a second threshold, and determining the text block as a frequency-modulation photo block when the value is greater than the second threshold.

By the above photo and text discriminating process, the photo is smoothed and/or an edge enhancement process is performed to the text, such that the output image is improved.

### BRIEF DESCRIPTION OF THE DRAWINGS

The above objects and advantages of the invention will be become more apparent by the following detailed description of the embodiments thereof with reference to the attached drawings, in which:

FIG. 1 is a flow chart showing the operation process of a photo and text discriminating method;

FIG. 2 shows the process to determine whether the text block is an amplitude-modulation halftone photo block; and

FIG. 3 shows the process to determine whether the text block is a frequency-modulation halftone photo block.

### DETAILED DESCRIPTION OF THE INVENTION

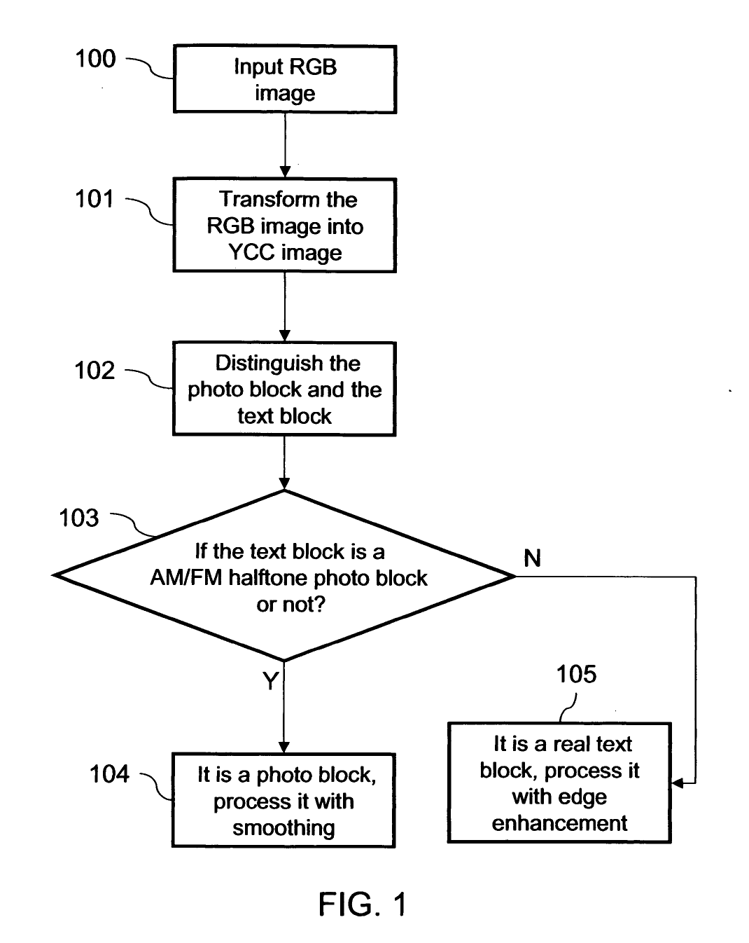

FIG. 1 depicts an embodiment of photo and text discriminating method.

A color image constructed of the three primary colors, red, green and blue is input (step 100). The color image is converted into a gray-scale YCC format image (step 101), and the converted image is then divided into a text block and a photo block (step 102). The text block is determined whether is amplitude modulated photo block or a frequency modulated photo block (step 103). If the text block remains a real text block, an edge enhancement process is performed to the text block (step 104). If the text block is determined to be a photo block in step 103, a smoothing process is performed to the text block (step 105). The processed text block is then combined with the photo block in the output image.

The sub-process of the above process is further described in detail as follows.

In the image processing, the image is divided into a plurality of blocks, and each of the image blocks includes an array of pixels. For example, each block may include an array of 8×8, 16×16, 32×32 or 64×64 pixel elements. The actual application is determined by the supporting hardware.

In the step of converting the RGB image into an YCC format image (step 102), a fixed-size image block is obtained from the YCC format image, and the brightness of each pixel in the block is obtained. By the “level crossing density” or the “peak density” technique, the text block and the photo block can be distinguished from the image block.

In the “level crossing density” technique, the number of pixels having a brightness exceeding a brightness threshold is different between the text and photo blocks. Generally speaking, the number of pixels having a brightness exceeding the brightness threshold of the photo block is larger than that of the text block. According to the number of pixels having brightness exceeding the brightness threshold, whether an image block is a photo block or a text block can be determined.

In the peak density technique, the peak-to-crest numbers and crest-to-peak numbers of an image block along the vertical and horizontal axes are calculated and counted. The sum of the peak-to-crest is then compared to a threshold value to determine whether the image block is a text block or a photo block.

However, as described, misjudgment often occurs in the above method that uses an image printed by the amplitude- or frequency-modulation screening techniques to distinguish the text and photo blocks. For example, the photo block is often determined to be and processed as a text block. That is, many of the text blocks as distinguished may contain photos. Therefore, a method to further confirm whether a text block contains an amplitude- or frequency-modulated photo block is provided to eliminate this misjudgment.

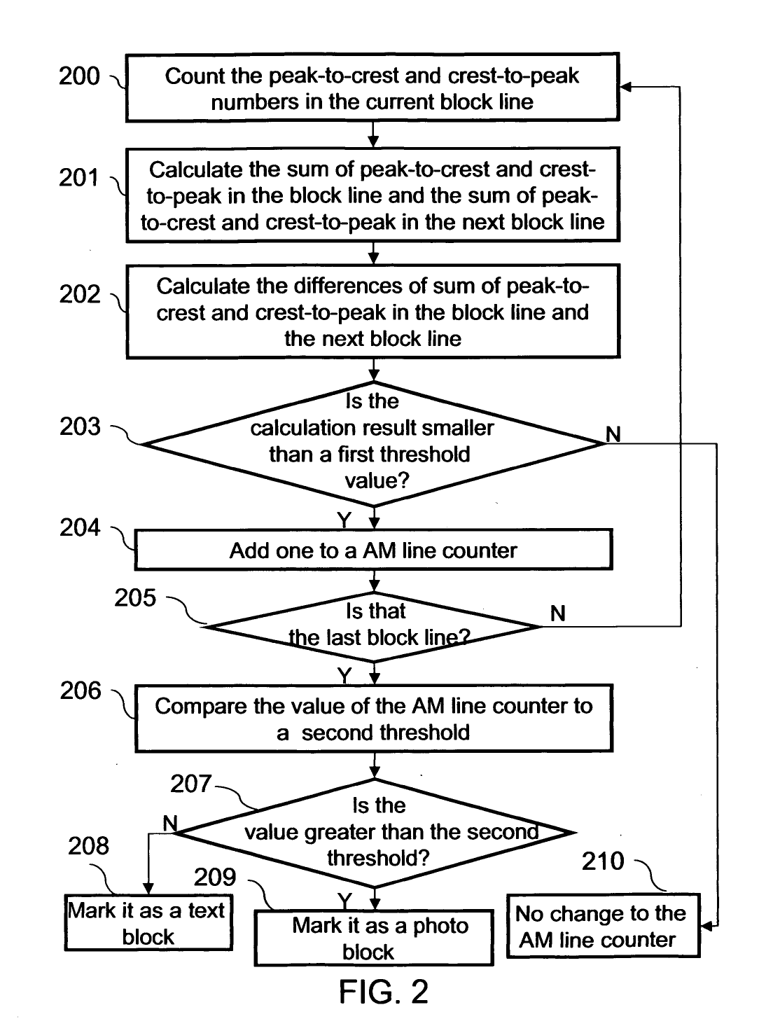

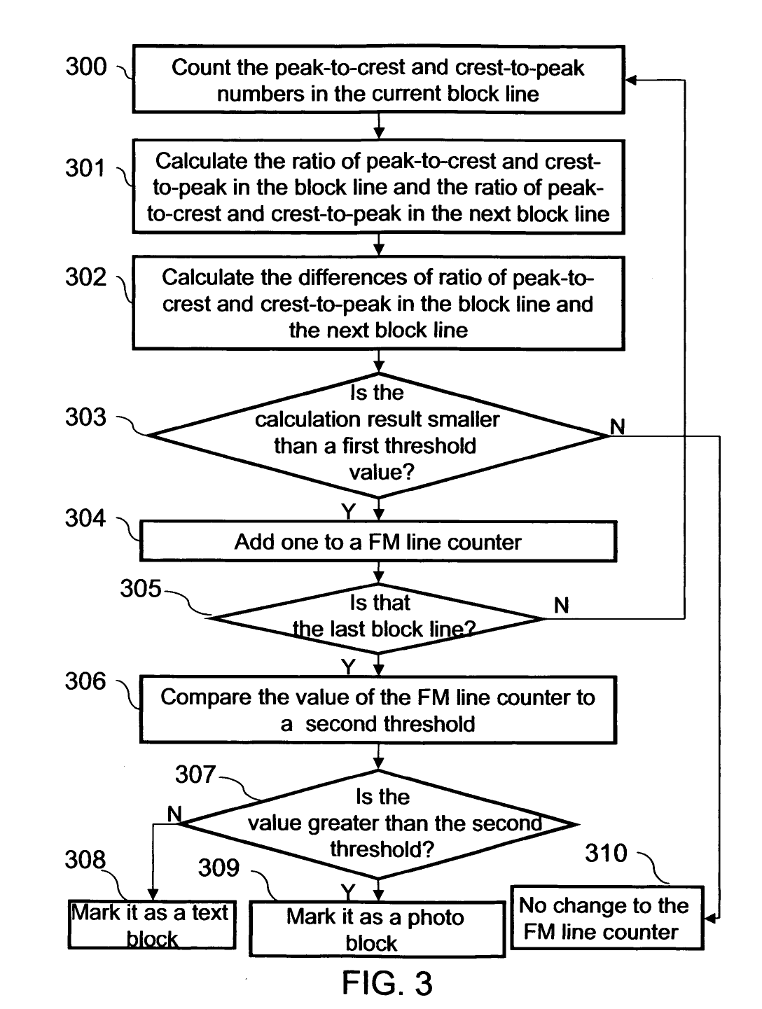

The step 103 of determining whether a text block is amplitude modulated halftone photo block or a frequency modulated halftone photo block is further explained with the reference of FIGS. 2 and 3.

FIG. 2 illustrates the flow chart to determine whether or not a text block is an amplitude modulated halftone photo block.

When a text block is received, the brightness of the pixels contained in the text block is obtained. The block is equidistantly and horizontally divided into a plurality of block lines. According to the distribution of brightness, the peak-to-crest number and the crest-to-peak number for each block line are calculated (step 200). The peak-to-crest number and the crest-to-peak number are added into a first summation (step 201).

When the process of the block is activated, the currently processing block line is referred to as the first block line. Alternatively, other block lines can be processed first.

The next block line is then processed in the same manner. That is, the summation of the next block line, or the second block line, is calculated. The difference between the first summation and the second summation is then calculated as a first difference (step 202).

The first difference is then compared to a first threshold. If the first difference is smaller than the first threshold (step 203), one is added to an amplitude-modulation counter (step 204). If not, the amplitude-modulation counter remains unchanged.

The above process continues until all the block lines have been calculated (step 205). The total number obtained by the amplitude-modulation counter is then compared to a second threshold (step 206). If the total number is larger than the second threshold (step 207), the block is determined to be an amplitude modulated halftone photo block (step 209), and a smoothing process by screening can be performed (step 104, as shown in FIG. 1). If the total number is smaller than the second threshold, the block is determined to be a text block (step 208), and an edge enhancement process can be performed (step 104 as shown in FIG. 1).

In step 205, when the block line being processed is not the last block line within the block, the calculation is then performed on the next block line (step 210), and the process returns to step 200.

FIG. 3 shows the process for determining whether a text block is a frequency modulated halftone photo block.

When a text block is received, the brightness of the pixels within the text block is obtained. The text block is then equidistantly and horizontally divided into a plurality of block lines. According to the brightness distribution of the pixels in the currently processed block line, the numbers of peak-to-crest and crest-to-peak are calculated (step 300). The ratio of the peak-to-crest and the crest-to-peak numbers is then obtained (step 301).

When the process of the text block is initiated, the initially processed block line is referred to as the first block line, and the next block line to be processed is referred to as the second block line. Alternatively, other block lines can be processed first.

Similarly, the ratio of the second block line is obtained. The ratio of the first block line is referred to as the first ratio, while the ratio of the second block line is referred to as the second ratio. The difference between the first and second ratio is obtained (step 302). This difference is referred to as a second difference.

The second difference is compared to the first threshold. If the second difference is smaller than the first threshold (step 303), one is added to the frequency-modulation counter (step 304). Otherwise, the frequency-modulation counter remains unchanged.

The above process continues until the calculation of all the block lines is complete. After confirms that all block lines have been calculated (step 305), the total number of the blocks obtained by the frequency-modulation counter is compared to the second threshold (step 306). If the total number is larger than the second threshold (step 307), the text block is determined to be a frequency modulated halftone photo block (step 309). If the total number is smaller than the second threshold, the text block is determined to be a real text block (step 308), and the edge enhancement process can be performed (step 104 of FIG. 1).

In addition, in step 305, if the currently processed block line is not the last block line of the block, the next block line will be processed, and the process returns to step 300.

In the process as shown in FIG. 1, the text block is further examined to determine whether it is an AM or FM halftone photo block. In practice, this step can be replaced by a step to determine whether it is an AM halftone photo block only, or whether it is a FM halftone photo block only. Either determination involves the calculation of the numbers of peak-to-crest and crest-to-peak. Therefore, to determine whether the text block is either the AM or FM halftone photo blocks, the numbers of the peak-to-crest and the crest-to-peak are calculated only once. In other words, only one calculation of the numbers of peak-to-crest and the crest-to-peak is required.

The first and second threshold can be determined or selected according to specific requirements. Preferably, the second threshold is larger than half of the block lines. For example, when the block is an array of 16×16 pixels, the preferable second threshold is 8.

In addition, the peak-to-crest or crest-to-peak is determined according to whether the continuous rising or falling values are larger than a third threshold such as 2, 3, 4 or 5.

By applying the photo and text discriminating method to a copier, a scanner or a multi-function printer, whether a text block containing a photo block formed of frequency-modulation or amplitude-modulation screening techniques can be confirmed. That is, the photo and text can be further distinguished to provide an improved image output.

While the invention has been particularly shown and described with reference to preferred embodiments thereof, it will be understood by those of ordinary skill in the art that various changes in form and details may be made therein without departing from the spirit and scope of the invention as defined by the appended claims.

What is claimed is:

1. A photo and text discriminating method, comprising:
obtaining a gray scale image;
dividing the gray scale image into a plurality of text blocks and a plurality of photo blocks; and
determining whether each of the text blocks comprise a photo block formed of amplitude- or frequency-modulation screening technique.

2. The method of claim 1, wherein the step of determining whether each text block includes the amplitude- or frequency-modulation photo block comprises:
partitioning the text block into a plurality of block lines; and
obtaining numbers of peak-to-crest and crest-to-peak for each block line according to brightness distribution thereof.

3. The method of claim 2, further comprising:
obtaining a sum of the numbers of peak-to-crest and crest-to-peak for each block line;
obtaining a difference of the sums between adjacent block lines;
comparing the difference to a first threshold;
adding one to an amplitude-modulation counter when the difference is smaller than the first threshold;
comparing a value of the amplitude-modulation counter to a second threshold; and
determining the text block as a real text block when the value is smaller than the second threshold, and determining the text block is a photo block when the value is greater than the second threshold.

4. The method of claim 2, further comprising:
obtaining a ratio between the numbers of peak-to-crest and crest-to-peak for each block line;
obtaining a difference of the ratios the adjacent block lines;
comparing the ratio to a first threshold;
adding one to a frequency-modulation counter when the difference is smaller than the first threshold; and
comparing a value of the frequency-modulation counter to a second threshold; and
determining the text block as a real text block when the value is smaller than a second
threshold and determining the text block as a photo block when the value is greater than the second threshold.

5. The method of claim 2, further includes a step of obtaining a brightness distribution for each block line before the step of partitioning the text block into a plurality of block lines.

6. The method of claim 1, wherein the gray scale image includes an YCC format image.

7. The method of claim 1, further comprising a smoothing step when the text block is determined as an amplitude- or frequency-modulated photo block.

8. The method of claim 1, further comprising a step of edge enhancement when the text block is determined as a real text block.
